(19) United States
(12) Patent Application Publication
(10) Pub. No.: US 2009/0291575 A1
(43) Pub. Date: Nov. 26, 2009

(54) Laser sealing of injector solenoids

(76) Inventors: James P. Henry, Noblesville, IN (US); Gary J. DeAngelis, Spencerport, NY (US)

Correspondence Address: Paul L. Marshall, Esq.;Delphi Technologies, Inc., Mail Code 480410202, P.O. Box 5052, Troy, MI, 48007, US

(21) Appl. No.: 12/154,360

(22) Filed: May 22, 2008

(51) Int. Cl. H01R 4/58

(52) U.S. Cl. 439/89

(57) ABSTRACT

A solenoid coil/connector assembly includes a coil assembly having coil wires wound around a bobbin, an overmold encapsulating the coil assembly, and a plurality of seals formed between the bobbin and the overmold using laser light, the seals hermetically sealing the coil wires. By using a laser welding process for plastic materials directed at an internal interface between the bobbin and overmold the coil wires become hermetically sealed and moisture is thus prevented from gaining access to coil wires during use of the solenoid coil/connector assembly.

### TECHNICAL FIELD

The present invention relates to electric solenoid actuators; more particularly, to solenoids for fuel injectors of internal combustion engines; and most particularly, to a hermetically sealed solenoid coil/connector assembly and a method for hermetically sealing electrical components of a fuel injector solenoid.

### BACKGROUND OF THE INVENTION

Fuel injectors for internal combustion engines are well known. A typical solenoid actuated fuel injector incorporates a metering poppet valve, a linear solenoid assembly for actuating the valve, and a plastic overmold for isolating the electrical components, such as the wire-wound bobbin of the solenoid assembly, from moisture and dirt. Overmolding a wound bobbin is a known form of protecting coil wires in fuel injectors and other solenoid actuated devices. In the prior art, it has proved difficult to provide a reliable hermetic seal between the wire-wound bobbin and the overmold. But sealing the wire-wound bobbin for protection from environmental elements is essential to long-term performance of the fuel injector. One of the issues with overmolding the wire-wound bobbin is that it is difficult to chemically bond the plastic of the overmold to the plastic of the bobbin even if similar materials are chosen. This is especially the case on flat surfaces, such as the axial or radial faces of the bobbin. The lack of a hermetic seal may allow fluids under pressure to migrate into the coil area and may lead to premature coil failure depending on the amount and type of fluid intrusion.

In order to achieve a dry coil design by creating a seal around the wire-wound bobbin of a solenoid actuated fuel injector, various concepts have been used in the past. These concepts include, for example, the use of o-rings, impregnation with sealants, such as adhesives, and redesigning the bobbin to include features that melt during the overmolding process to cause interstitching between the bobbin material and the overmold material. Such seals offer some improvement in performance but include additional parts, are more expensive to install or manufacture, and are vulnerable to damage during assembly of a solenoid, thus negating their advantage. Further, damage to an o-ring or seal may not be readily identified at the time the damage occurs and may become evident only upon failure of the solenoid in customer usage.

What is needed in the art is a hermetically sealed coil assembly of a solenoid that is able to avoid migration of fluid under pressure into the coil area.

It is a principal object of the present invention to provide a hermetically sealed coil assembly of a solenoid by isolating the coil area without added parts or sealants.

It is a further object of the invention to provide a method for creating a hermetic seam between plastic parts on flat surfaces.

It is a still further object of the invention to improve the durability and performance of a fuel injector for an internal combustion engine.

### SUMMARY OF THE INVENTION

The present invention addresses the shortcomings of the prior art by providing a hermetically sealed overmolded coil assembly of a solenoid by creating internal hermetical seams between the bobbin flanges and the overmold material. The hermetic seam may be positioned between layers of a solenoid coil/connector assembly, such as at the faces and/or side faces of the bobbin flanges and the overmold.

A laser welding process for plastic materials, which is a known type of fusion welding, is used to create the hermetical seals at the bobbin and overmold interface.

Plastic laser welding is accomplished by exposing parts to be joined to near infrared light. A material capable of adsorption in the near infrared spectrum converts the laser energy into heat. Typically the outer plastic layer, such as the overmold material, is optically transparent to the near infrared spectrum of the laser light and the inner layer, such as the bobbin material is absorbent to the laser energy. Laser light is absorbed at the surface of the inner material, which causes heat to build up at the surface of the inner layer and the surface of the outer layer. The laser beam focused toward the seam area causes the material of the inner and outer layer to change from a solid to a liquid state. Intimate contact between the outer and lower surfaces to be sealed is provided to ensure heat transfer and bonding. On removal of the laser as the heat source, the materials re-solidify almost instantaneously to produce an adherent plastic weld. The result of the laser welding process is a hermetically sealed weld with minimal thermal and mechanical stress, no particulates, and very little flash. The cycle times for laser welding of plastic materials are typically relatively short. The laser welding process can be used for creating hermetic seals in rigid or flexible materials and small or large parts.

The near infrared laser light is used in accordance with the invention to locally heat the material of the bobbin and to effectively melt both materials at the interface between the bobbin and the overmold. On removal of the laser, the molten materials resolidify and a hermetic seam between the bobbin and the overmold is formed. By using the laser welding process to hermetically seal the interfaces between the top flange and the bottom flange of the bobbin and the overmold, the coil wires become hermetically sealed to external fluids, improving the durability and performance of the solenoid coil/connector assembly. By including such a solenoid coil/connector assembly in a fuel injector assembly of an internal combustion engine, the reliability of such a fuel injector may be improved and the working life may be prolonged. Furthermore, by using the laser welding process to hermetically seal the interfaces between the top flange and the bottom flange of the bobbin and the overmold, added parts, such as o-rings, or added sealants can be eliminated.

### BRIEF DESCRIPTION OF THE DRAWINGS

The present invention will now be described, by way of example, with reference to the accompanying drawings, in which:

FIG. 1 is a top plan view of a hermetically sealed solenoid coil/connector assembly in accordance with the invention; and

FIG. 2 is an elevational cross-sectional view of the hermetically sealed solenoid coil/connector assembly in accordance with the invention, taken along line 2-2 in FIG. 1.

### DESCRIPTION OF THE PREFERRED EMBODIMENTS

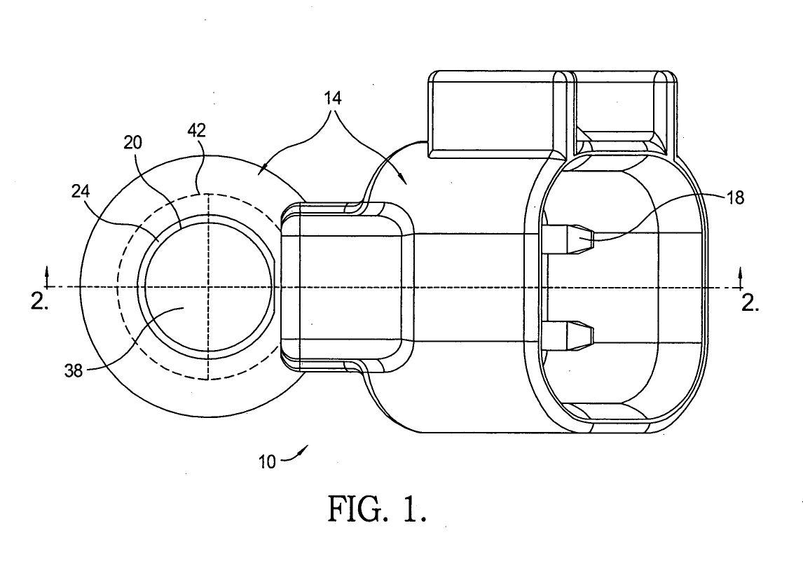

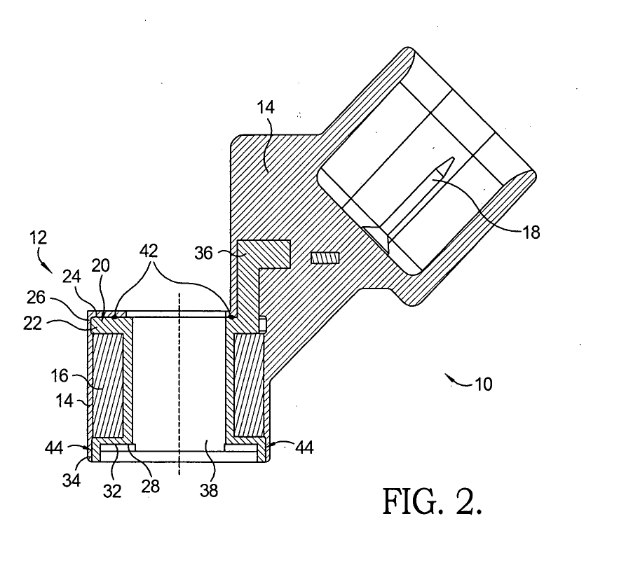

Referring to FIGS. 1 and 2, a hermetically sealed solenoid coil/connector assembly 10 includes a coil assembly 12 encapsulated by an overmold 14. Coil assembly 12 includes coil wires 16 wound conventionally around a bobbin 20. Bobbin 20 includes a bobbin extension 36 connected to a spade connector 18. Bobbin 20 may further include a top flange 22 having an axial outer face 24 and a side radial face 26 and a bottom flange 28 having an axial outer face 32 and a side radial face 34. Side radial face 26 defines the outer circumferential contour of top flange 22 and side radial face 34 defines the outer circumferential contour of bottom flange 28. Bobbin 20 is provided with a center aperture 38. Center aperture 38 may be appropriately sized for receiving a pole piece. Solenoid coil/connector assembly 10 may be used, for example, in an assembly of a solenoid actuated fuel injector of an internal combustion engine, in known fashion that need not be further elaborated herein.

Overmold 14 may be formed during an injection molding process. The overmold material may be any polymer material that is suitable for injection molding and that is optically transparent to the near infrared spectrum of a laser. A currently preferred material is, for example, nylon 6/6 that has a natural color.

Bobbin 20 may be formed of any polymer material that is able to absorb the near infrared light of a laser. Various methods of making a plastic material absorb the laser energy are known in the art. For example, the plastic material may be impregnated with carbon to become opaque. Near infrared-absorbent pigments have been created that can be incorporated in the plastic material to make it suitable for laser welding. A currently preferred material is, for example, nylon 6/6 that has a black color.

As described above, a problem inherent to the prior art manufacture of dry coil designs is that the liquid polymer may fail to bond to the surface of bobbin 20 to create a hermetic seal between them by injection molding alone.

In accordance with the invention as shown in FIGS. 1 and 2, an upper seal 42 and a lower seal 44 are formed using laser light between overmold 12 and bobbin 20 to hermetically seal the area of coil wires 16. Upper seal 42 and lower seal 44 are preferably formed by a laser welding process. Transmission laser welding involves localized heating at an interface of bobbin 20 and overmold 14 where bobbin 20 and overmold 14 are to be sealed to produce a strong, hermetically sealed seam with minimal thermal and mechanical stress, no particulates, and very little flash. A relatively light clamping pressure is required to keep bobbin 20 and overmold 14 stationary and to ensure that there is no gap between the surfaces to be sealed. The laser may be focused onto a single point that is then traced along the length of the seal, upper seal 42 or lower seal 44. The laser may be moved along the seal line either by fixing the solenoid coil/connector assembly 10 to an x-y table, by attaching the laser to a robotic arm, or a combination of the two. Various types of lasers may be employed, for example, diode or fiber lasers transmitting light in the 810-980-nanometer wavelength range, Co₂ gas lasers transmitting light at about 10.6 micrometers, and solid state lasers (YAG type) transmitting light at about 1.06 micro-meters.

During the laser welding process, the laser beam is focused on a specific area on the material, for example, axial outer face 24 or side radial face 26 of top flange 22 or axial outer face 32 or side radial face 34 of bottom flange 28. The laser light penetrates the material of overmold 14, which is optically transparent to the near infrared spectrum of the laser light, and is absorbed by the opaque material of bobbin 20. Absorption of the laser light at the surface of bobbin 20 causes heat to build up, which is conducted into the sealing area causing the material of bobbin 20 and overmold 14 to change from a solid state to a liquid state in this area and to combine the two liquefied materials.

Intimate contact between overmold 14 and bobbin 20 in the area to be sealed is essential to ensure heat transfer and sealing. A force may be applied externally to overmold 14 to ensure that overmold 14 is in direct contact with a surface, such as face 24 or face 26 of top flange 22 or face 32 or face 34 of bottom flange 28, of bobbin 20. On removal of the laser beam and, therefore, the heat, the liquefied material solidifies to produce a hermetic seal. Accordingly, the hermetic seal is an internal hermetic seam between layers of a part such as solenoid coil/connector assembly 10. The seal is produced almost instantaneously after removal of the heat, which leads to relatively short cycle times. The technology of the laser welding allows such a hermetic seal to be created between plastic parts on flat surfaces, as needed to hermetically seal solenoid coil/connector assembly 10.

To hermetically seal the coil wires 16 of solenoid coil/connector assembly 10, upper seal 42 and lower seal 44 may be formed in a preferred embodiment as shown in FIGS. 1 and 2. Upper seal 42 may be positioned at face 24 of top flange 22 of bobbin 20. Upper seal 42 may be a continuous seam having a generally circular shape. Lower seal 44 may be positioned at side radial face 34 of bottom flange 28 of bobbin 20. Lower seal 44 may be a continuous radial seam. By providing a continuous upper seal 42 that is positioned above coil wires 16 as well as a continuous lower seal 44 that is positioned below coil wires 16, solenoid coil/connector assembly 10 can be hermetically sealed to external fluids even if these fluids are pressurized. Pressurized fluids may be present, for example, when solenoid coil/connector assembly 10 is part of a fuel injector assembly of an internal combustion engine.

Depending on the design of overmold 14 and bobbin 20, upper seal 42 and lower seal 44 may be positioned in different locations. For example, upper seal 42 may be positioned at side radial face 26 of top flange 22 and lower seal 44 may be positioned at axial outer face 32 of bottom flange 28. It may further be possible to position both, upper seal 42 and lower seal 44, at the faces 24 and 32 of top and bottom flanges 22 and 28, respectively. It may further be possible to position both, upper seal 42 and lower seal 44, at faces 26 and 34 of top and bottom flanges 22 and 28, respectively.

By hermetically sealing top flange 22 and bottom flange 28, coil wires 16, the electrical components of coil assembly 12, become hermetically sealed and moisture is thus prevented from gaining access to coil wires 16 during use of solenoid coil/connector 10 assembly, which may improve the durability and performance of solenoid coil/connector assembly 10.

While solenoid coil/connector assembly 10 has been described for use in solenoid actuated fuel injectors of internal combustion engines, other applications are possible.

While faces 24 and 32 and side faces 26 as well as 34 of top and bottom flanges 22 and 28, respectively, have been described as locations for upper seal 42 and lower seal 44, other locations may be possible.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A solenoid coil/connector assembly, comprising:
a coil assembly including coil wires contained by a bobbin;
an overmold encapsulating said coil assembly wherein at least a portion of said bobbin is disposed below an outer surface of said overmold; and
at least one seal formed between said bobbin and said overmold using laser light wherein said at least one seal is formed below said outer surface of the overmold; and
wherein said at least one seal seals said coil wires.

2. The solenoid coil/connector assembly of claim 1, wherein said seals include a continuous upper seal positioned above said coil wires and a continuous lower seal positioned below said coil wires.

3. The solenoid coil/connector assembly of claim 2, wherein said upper seal is positioned at a face of a top flange of said bobbin, and wherein said upper seal is a continuous seam having a generally circular shape.

4. The solenoid coil/connector assembly of claim 2, wherein said lower seal is positioned at a side face of a bottom flange of said bobbin, and wherein said lower seal is a continuous radial seam.

5. The solenoid coil/connector assembly of claim 1, wherein said overmold is formed of a polymer material that is suitable for injection molding and that is optically transparent to a near infrared spectrum of said laser light.

6. The solenoid coil/connector assembly of claim 1, wherein said bobbin is formed of a polymer material that is able to absorb a near infrared spectrum of said laser light.

7. The solenoid coil/connector assembly of claim 1, wherein said overmold is in direct contact with a surface of said bobbin at a location of said at least one seal.

8. The solenoid coil/connector assembly of claim 1, wherein said at least one seal seals said coil wires to external pressurized fluids.

9. The solenoid coil/connector assembly of claim 1, wherein said at least one seal is formed by melting and resolidifying material at an interface between said overmold and said bobbin.

10. The solenoid coil/connector assembly of claim 1, wherein said solenoid coil/connector assembly is part of a fuel injector assembly of an internal combustion engine.

11. A solenoid of a fuel injector of an internal combustion engine, comprising:
a coil assembly including coil wires contained by a bobbin;
an overmold encapsulating said coil assembly wherein at least a portion of said bobbin is disposed below an outer surface of said overmold;
an first seal formed by laser light and positioned at a face of a top flange of said bobbin; and
a second seal formed by laser light positioned at a face of a bottom flange of said bobbin;
wherein said first seal and said second seal protect said coil wires from moisture.

12. The solenoid of claim 11, wherein said first seal is a continuous seam having a generally circular shape.

13. The solenoid of claim 11, wherein said second seal is a continuous radial seam.

14. The solenoid of claim 11, wherein said overmold is formed of nylon 6/6 having a property that is optically transparent to a near infrared spectrum of said laser light.

15. The solenoid of claim 11, wherein said bobbin is formed of nylon 6/6 having a property that absorbs a near infrared spectrum of said laser light.

16. A method for hermetically sealing electrical components of a fuel injector solenoid, comprising the steps of:
encapsulating a coil assembly with an overmold wherein said coil assembly includes coil wires contained by a bobbin;
utilizing laser light to create at least one of a first seal and a second seal between said overmold and said bobbin; and
sealing said coil wires to pressurized fluids with said at least one of said first and second seals.

17. The method of claim 16, further comprising the steps of:
bringing said overmold in direct contact with a face of said bobbin;
penetrating said overmold with said laser light in an area of said contact;
building up heat at said area of contact to melt at least one of said overmold or said bobbin;
removing said laser light; and
resolidifying at least one of said melted overmold or said bobbin to create said at least one of said first and a second seals.

18. The method of claim 16, further comprising the step of:
forming said overmold by injection molding.

19. The method of claim 16, further comprising the steps of:
forming said overmold from a moldable polymer material that is optically transparent to a near infrared spectrum of said laser light; and
forming said bobbin from a polymer material that is absorbent to a near infrared spectrum of said laser light.
